(19) United States
(12) Patent Application Publication
(10) Pub. No.: US 2025/0330089 A1
(43) Pub. Date: Oct. 23, 2025

(54) BOOST CONVERTERS

(71) Applicant: Nordic Semiconductor ASA, Trondheim (NO)

(72) Inventors: Juha-Matti KUJALA, Oulu (FI); Erkki NOKKONEN, Oulu (FI); Pekka Ilkka ROIVAINEN, Oulu (FI); Anssi PARTANEN, Oulu (FI)

(73) Assignee: Nordic Semiconductor ASA, Trondheim (NO)

(21) Appl. No.: 19/176,437

(22) Filed: Apr. 11, 2025

(30) Foreign Application Priority Data
Apr. 18, 2024 (GB) 2405479.3

(51) Int. Cl. H02M 3/158; H02J 7/00

(52) U.S. Cl. CPC H02M 3/158; H02J 7/0063; H02J 7/007; H02J 2207/20

(57) ABSTRACT

A boost converter circuit is provided comprising an input arranged to receive an input voltage from a power source; an output arranged to generate a higher, output voltage for powering a further circuit portion; and a boost circuit portion operable to transfer energy from the input to the output. The boost converter circuit is arranged to operate in a discontinuous boost mode in which, when the output voltage is below a target output voltage, the boost converter circuit alternates between an active state in which the boost circuit portion transfers energy from the input to the output and an inactive state in which the boost circuit portion is turned off and energy is not transferred from the input to the output.

### CROSS-REFERENCE TO RELATED APPLICATION

This application claims priority from United Kingdom Patent Application No. 2405479.3, filed Apr. 18, 2024, which application is incorporated herein by reference in its entirety.

### BACKGROUND OF THE INVENTION

The present invention relates to boost converter circuits and related circuits.

Electronic devices are often powered using direct current (DC) power sources such as batteries. In many cases the unloaded (also referred to as nominal) voltage of the power source does not match one or more voltage requirements of the electronic device, and can also vary according to the age of the power source, its state of charge and/or ambient conditions (e.g. temperature). For instance, a particular single cell battery might generate an unloaded voltage of between 1.5 V and 1.7 V when it is fully charged, and between 0.9 V and 1.1 V when nearly fully discharged. Many electronic devices often require higher voltages to operate, such as 3 V or 5 V.

Some devices utilise a boost converter (also known as a step-up converter) to step up an input voltage (e.g. from a low-voltage battery) to a higher output voltage suitable for operating the device, whilst correspondingly stepping down an input current to a lower output current. Conservation of energy dictates that the input and output voltage and current of a boost converter are related according to:

$${I}_{out} = K ( \frac{{V}_{in}}{{V}_{out}} ) {I}_{in} , \qquad ( 1 )$$

where Iᵢₙ, Iₒᵤₜ, Vᵢₙ and Vₒᵤₜ are the input and output currents and voltages, and K is the efficiency of the boost converter.

The voltage Vᵢₙ and current Iᵢₙ supplied by a power source, its unloaded operating voltage Vᵤₙₗ and its internal resistance Rᵢₙₜ are related according to:

$${V}_{in} = {V}_{unl} - {I}_{in} {R}_{int} , \qquad ( 2 )$$

$$∴ {I}_{in} = \frac{{V}_{unl} - {V}_{in}}{{R}_{int}} . \qquad ( 3 )$$

Combining equations (1) and (3) means that the output current of a boost converter, Iₒᵤₜ, can be expressed as:

$$\begin{matrix}{I}_{out} & = & K ( \frac{{V}_{in}}{{V}_{out}} ) ( \frac{{V}_{unl} - {V}_{in}}{{R}_{int}} ) & ( 4 ) \\ & = & ( \frac{K}{{V}_{out} {R}_{int}} ) ( {V}_{unl} {V}_{in} - {V}_{in}^{2} ) . & ( 5 ) \\ & & & \end{matrix}$$

In some implementations, a load may demand for short periods of time a current that exceeds what can be sustainably delivered by the boost converter alone (i.e. exceeding the maximum value of the right hand side of equation (1)). When the output current demand exceeds the output current of the boost converter, the output voltage drops.

Similarly, when an input current demanded by the boost converter exceeds that which can be sustainably delivered by the power source, the input voltage may drop. This can reduce efficiency due to losses over the power source's internal resistance.

Many boost converter implementations include one or more decoupling capacitors (decaps) connected in parallel with the load, to provide a charge buffer that can allow large output currents to be provided for short pulses. The decap provides a short-term charge reservoir for the load pulses and is then recharged by the boost converter between the load pulses.

Using a decoupling capacitor to supply high current to transient load pulses, and using the boost converter to recharge the capacitor with a continuous low recharge current can be quite efficient. A reduced recharge (output) current from the boost converter requires a reduced input current from the power source (as per equation (1)), which can reduce voltage drop and associated resistive losses.

However, further efficiency improvements may be desired.

### SUMMARY OF THE INVENTION

According to a first aspect of the present invention there is provided a boost converter circuit comprising:
an input arranged to receive an input voltage from a power source;
an output arranged to generate a higher, output voltage for powering a further circuit portion; and
a boost circuit portion operable to transfer energy from the input to the output;
   wherein the boost converter circuit is arranged to operate in a discontinuous boost mode in which, when the output voltage is below a target output voltage, the boost converter circuit alternates between an active state in which the boost circuit portion transfers energy from the input to the output and an inactive state in which the boost circuit portion is turned off and energy is not transferred from the input to the output.

Thus, it will be appreciated by those skilled in the art that, by alternating between the active and inactive states when the output voltage is below the target output voltage, energy losses due to quiescent current consumed by the boost circuit portion may be reduced. Conventionally, a boost converter circuit operates continuously when the output voltage is below a target output voltage, but the inventors have recognised that improved overall efficiency may be achieved by following this different approach.

Operating the boost circuit portion only intermittently when the output voltage is below the target output voltage reduces the overall duration for which it is delivering an output current compared to conventional continuous boost operation, potentially reducing an overall average output current that can be provided. However, this may be partly or entirely compensated by the fact that the input voltage will recover towards an unloaded value when in the inactive state, allowing the boost converter circuit to deliver a higher output current in the active state (i.e. allowing more energy to be transferred by the boost circuit portion). As such, the overall efficiency of the boost converter circuit may be significantly improved. In other words, the boost operation occurring discontinuously effectively limits the average input current drawn from the power source for powering the output without needing to continuously power all parts of the boost converter circuit and potentially incur a comparable quiescent current.

Whilst the overall average output current may be slightly lower than that achievable with continuous boost converter operation, the inventors have recognised that in many situations this may be acceptable in return for the potentially significant improvements in efficiency attained by mitigating quiescent currents. Moreover, a decrease in average output current can in many implementations be easily compensated for, e.g. by using decoupling capacitors to provide charge reservoirs for load current pulses.

The boost circuit portion may comprise or be connected to an inductor with a first terminal connected to the input. The boost converter circuit may be arranged to perform boost cycles in which a second terminal of the inductor is alternately connected to ground and to the output. It will be appreciated that these boost cycles repeatedly store energy from the input in the magnetic field of the inductor and then release this to produce a boosted output voltage at the output.

The boost circuit portion may comprise a switching arrangement arranged to selectively connect a second terminal of the inductor to ground or to the output. The switching arrangement may comprise a transistor (e.g. a MOSFET) connected between the second terminal of the inductor and ground. The switching arrangement may comprise a second transistor connected between the second terminal of the inductor and the output. The boost circuit portion may comprise a diode connected between the second terminal of the inductor and the output. The boost circuit portion may comprise one or more bias current generators for use with the transistor(s).

The boost circuit portion may comprise a control portion arranged to control operation of the switching arrangement to alternately connect the second terminal of the inductor to ground and to the output. The control portion may comprise an oscillator. The control portion may comprise one or more logic circuits arranged to control operation of the switching arrangement in response to a signal from the oscillator.

The boost circuit portion may be voltage-mode controlled, i.e. wherein the control portion is arranged to control operation of the switching arrangement in response to the output voltage and/or the input voltage. For instance, the control portion may be arranged to adjust one or more parameters of the boost cycles (e.g. duty cycle) in response to the output voltage and/or the input voltage (e.g. in response to a comparison between the output voltage and a target voltage, or a comparison between the input voltage and a minimum allowable voltage).

The control portion may be arranged to operate the boost circuit portion so that the input voltage is maintained above a minimum allowable voltage. The maximum of equation (5) is found when

$${V}_{in , max} = \frac{{V}_{unl}}{2} .$$

In other words, the theoretical maximum output current of the boost converter occurs when the input voltage drops to half of its unloaded value. Accordingly, the minimum allowable input voltage may be equal to half or approximately half of an unloaded voltage (e.g. between 35% and 65% of an unloaded voltage or between 45% and 55% of an unloaded voltage).

The boost converter circuit may comprise one or more comparators. The boost converter circuit may comprise an input voltage comparator for comparing the input voltage with a reference input voltage (e.g. a minimum allowable input voltage). The boost converter circuit may comprise an output voltage comparator for comparing the output voltage with a reference output voltage (e.g. a minimum allowable output voltage). The comparator(s) may operate directly on the input and/or output voltage(s), or on corresponding voltage(s) (e.g. a divided version thereof). The boost converter circuit may comprise one or more reference voltage supplies for providing a reference input or output voltage.

As explained above, the boost circuit portion is turned off in the inactive state. This may comprise one, some or all components of the boost circuit portion being turned off. For instance, the boost circuit portion may comprise one or more oscillators, logic circuits, comparators, reference voltage supplies and/or bias current generators which may be arranged to turn off in the inactive state to reduce quiescent current flow. Turning off a component may comprise disconnecting a supply voltage and/or lowering a logical enable signal.

In a set of embodiments, the boost converter circuit comprises one or more input capacitors connected in parallel with the input. In some embodiments, the boost converter circuit comprises one or more output capacitors connected in parallel with the output. Input and output decoupling capacitor(s) may act as charge reservoirs for moments of high current demand. For instance, providing one or more output capacitors may allow a current demanded by the further circuit portion to be met for a short period of time even if the maximum output current of the boost converter circuit is less than that an instantaneous current demanded by the further circuit portion. This may facilitate the extraction of more useful energy from the power source, because a lower current (with lower associated resistive losses) may be drawn from the power source over a longer time period, with the capacitor(s) making up any current shortfall in moments of high demand and then being recharged with the lower current afterwards.

When the boost circuit portion is transferring energy from the input to the output, the input voltage will drop due to internal resistance in the power source. It may be desirable to prevent the input voltage dropping too far, e.g. to avoid excessive losses over an internal resistance in the power source. In some embodiments, the boost converter circuit is arranged such that the input voltage does not drop below a minimum input voltage when in the active state (e.g. in the discontinuous boost mode or otherwise).

In some embodiments, the boost converter circuit is arranged, when in the discontinuous boost mode, to transition from the active state to the inactive state based directly on the input voltage. The boost converter circuit may be arranged to detect the input voltage and transition from the active state to an inactive state when the input voltage reaches a minimum input voltage. As explained above, the input voltage can then recover in the inactive state before entering into the active state once again. It will be appreciated that in such embodiments, the duration for which the boost converter circuit is in the active state may vary depending on the instantaneous load being drawn from the output and the condition of the power source (e.g. an age or charge state of a battery) during a period of active state operation. The boost converter circuit may transition from the active state to the inactive state in response to an output from an input comparator (e.g. the same comparator used for boost cycle control).

Controlling the use of the active state based on direct feedback on the input voltage may, however, require the use of potentially bulky and power-hungry hardware (e.g. a comparator), as well as introducing a possible source of control lag. Therefore, in a set of embodiments the use of the active state may be based on other factors.

For instance, the use of the active state may be time-based. In a set of embodiments, the boost converter circuit is arranged, when in the discontinuous boost mode, to operate in the active state for a predetermined active duration before transitioning to the inactive state. In a set of embodiments, the boost converter circuit comprises a timer arranged to measure the predetermined active duration and trigger a transition into the inactive state when the predetermined active duration elapses.

The active duration may be selected such that the input voltage does not reach or fall below a minimum input voltage during the period of active state operation. The predetermined active duration may be fixed for all periods of active state operation (e.g. based on expected load and power source characteristics) or it may be selected dynamically (e.g. each before the active state is entered) by the boost converter circuit based on current conditions (e.g. based on information about the load being drawn and/or or the condition of the power source).

Additionally or alternatively, the use of the active state may be based on counting cycles of boost conversion operation. In a set of embodiments, the boost converter circuit is arranged, when in the discontinuous boost mode, to operate in the active state for a predetermined number of boost cycles before transitioning to the inactive state (i.e. a boost cycle limit). In a set of embodiments, the boost converter circuit comprises a counter arranged to measure the predetermined number of boost cycles and a boost cycle limiter arranged to trigger a transition into the inactive state when the predetermined number of boost cycles elapses.

The boost cycle limit may be selected such that the input voltage does not reach or fall below a minimum input voltage during the period of active state operation. The number of boost cycles may be fixed for all periods of active state operation (e.g. based on expected load and power source characteristics) or it may be selected (e.g. each time the active state is entered) by the boost converter circuit based on one or more present conditions of the boost converter circuit (e.g. based on information about the load being drawn and/or or the condition of the power source).

In some embodiments, the boost converter circuit is arranged, when in the discontinuous boost mode, to transition from the inactive state to the active state based directly on the input voltage. For instance, the boost converter circuit may be arranged to detect the input voltage and transition from the inactive state to the active state when the input voltage reaches a threshold voltage (e.g. based on an unloaded power source voltage). This may ensure that the input voltage has recovered sufficiently before the next active period.

In some embodiments, additionally or alternatively, the use of the inactive state is time-based. In a set of embodiments, the boost converter circuit is arranged, when in the discontinuous boost mode, to operate in the inactive state for a predetermined inactive duration before transitioning to the active state. The inactive duration may be selected such that the input voltage recovers to a desired level during the period of inactive state operation. The inactive duration may be fixed for all periods of inactive state operation (e.g. based on expected load and power source characteristics) or it may be selected (e.g. each time the inactive state is entered) by the boost converter circuit based on one or more present conditions of the boost converter circuit (e.g. based on information about the load being drawn and/or or the condition of the power source).

More generally, the boost converter circuit may be arranged to control the durations of active and inactive state operation such that the boost converter circuit can provide sufficient current to meet an expected load without the output or input voltages dropping below acceptable limits. The boost converter circuit may take into account one or more of: an expected load current and duration; a capacity of input and/or output capacitors; an unloaded voltage of the power source; and age or discharge state of the power source.

In a set of embodiments, the boost converter circuit comprises a discontinuous operation circuit portion arranged to control the boost circuit portion in the discontinuous boost mode. The discontinuous operation circuit portion may comprise a boost cycle counter for counting boost cycles in the active mode. The discontinuous operation circuit portion may comprise a boost cycle limiter which triggers a transition to the inactive mode when a boost cycle limit is reached. The discontinuous operation circuit portion may comprise a time-out timer arranged to measure periods of inactive state operation and trigger a transition to the active state when the inactive duration expires. The timer-out timer remains turned on in the inactive mode. The time-out timer may be the only component of the boost converter circuit that remains turned on in the inactive mode.

In some embodiments, the boost converter circuit is arranged to operate only in the discontinuous boost mode (e.g. the boost converter circuit may only be operable in the discontinuous boost mode. In other words, the discontinuous boost mode may be the only mode in which the boost converter circuit transfers energy from the input to the output. This may simplify circuitry and/or lead to further improvements in efficiency.

However, in a set of embodiments, the boost converter circuit is also operable in a continuous boost mode in which, when the output voltage is below a target output voltage, the boost circuit portion continuously transfers energy from the input to the output (i.e. in which there are no inactive periods). In some embodiments, it may be useful to operate in the continuous boost mode when an output current is low, and to operate in the discontinuous boost mode when the output current is high (e.g. for short high load pulses).

The boost converter circuit may operate in the continuous boost mode or the discontinuous boost mode in response to an external signal indicating an output load level. For instance, the boost converter circuit may be arranged to operate in the discontinuous boost mode in response to a signal (e.g. from the further circuit portion) indicating a load pulse start. Conversely, the boost converter circuit may be arranged to operate in the continuous boost mode in response to a signal (e.g. from the further circuit portion) indicating the end of a load pulse.

However, the use of external signals may not be suitable for all implementations. In a set of embodiments, the boost converter circuit is arranged to operate in the continuous boost mode or the discontinuous boost mode in response to a level of or change in the input and/or output voltage. For instance, the boost converter circuit may be arranged to operate in the discontinuous boost mode in response to a drop in the input voltage, the output voltage or both. A simultaneous drop in input and output voltage may be a strong indication of a large output current being drawn.

However, in some embodiments the boost converter circuit is arranged to operate in the discontinuous boost mode in response to (only) a drop in the output voltage. This may trigger discontinuous boost mode earlier than waiting for drops in both the input and output voltages, potentially avoiding inefficient operation at the start of a load pulse. This may allow the input voltage to be maintained at a higher level throughout the load pulse, further improving efficiencies. Not needing to detect a drop in input voltage for this purpose may also allow circuitry to be simplified.

Conversely, the boost converter circuit may be arranged to transition to the continuous boost mode from the discontinuous boost mode in response to an increase in the input voltage, the output voltage or both, e.g. once the load pulse and subsequent recharging has been completed. It will be understood that being in the continuous boost mode in which the boost circuit portion continuously transfers energy when the output voltage is below the target does not exclude the boost converter circuit from operating discontinuously when the output voltage is at or above the target output voltage (e.g. pulse-frequency modulation operation).

As explained above, the periods of active and inactive state operation in the discontinuous boost mode may be tuned for expected loads and power supply performance. However, if the system does not operate as expected there is a risk that the discontinuous boost mode operation cannot sustain a sufficient output voltage for an entire load pulse. Thus, in a set of embodiments, the boost converter circuit is arranged to transition to the continuous boost mode from the discontinuous boost mode if the output voltage drops below a minimum allowable level. Returning to the continuous boost mode early may allow for continued operation in case of an unexpectedly large or long load pulse and/or unexpectedly poor power source performance.

The invention extends to a circuit system comprising:
a power source arranged to generate an input voltage; and the boost converter circuit as disclosed herein, wherein the input is connected to the input voltage generated by the power source.

The power source may comprise a battery. The battery may comprise a low capacity battery, e.g. a single cell battery, with a capacity of 2000 mWh, less than 1000 mWh, less than 500 mWh or less than 250 mWh. The battery may comprise a button cell or coin battery such as a CR2032 battery. The power source may comprise an unloaded voltage of between 0.5 V and 5 V, e.g., of at least 0.7 V, 0.9 V or 1.1 V and/or of less than 4 V, 3 V, 2V or 1.7 V. The power source may comprise an internal resistance of 1 Ω or more, 5 Ω or more, 10 Ω or more or 20 Ω or more.

The circuit system may comprise a further circuit portion (e.g. a System-on-Chip) connected to the output. The further circuit portion may have a minimum operational voltage. The boost converter circuit may be arranged to maintain the output voltage above the minimum operational voltage.

Features of any aspect or embodiment described herein may, wherever appropriate, be applied to any other aspect or embodiment described herein. Where reference is made to different embodiments, it should be understood that these are not necessarily distinct but may overlap.

### BRIEF DESCRIPTION OF THE DRAWINGS

One or more non-limiting examples will now be described, by way of example only, and with reference to the accompanying figures in which:

FIG. 1 is a schematic diagram of a circuit system according to an embodiment of the present invention

FIG. 2 is a timing diagram illustrating operation of the circuit system using only a continuous boost mode; and

FIG. 3 is a timing diagram illustrating operation of the circuit system according to an embodiment of the invention.

### DETAILED DESCRIPTION

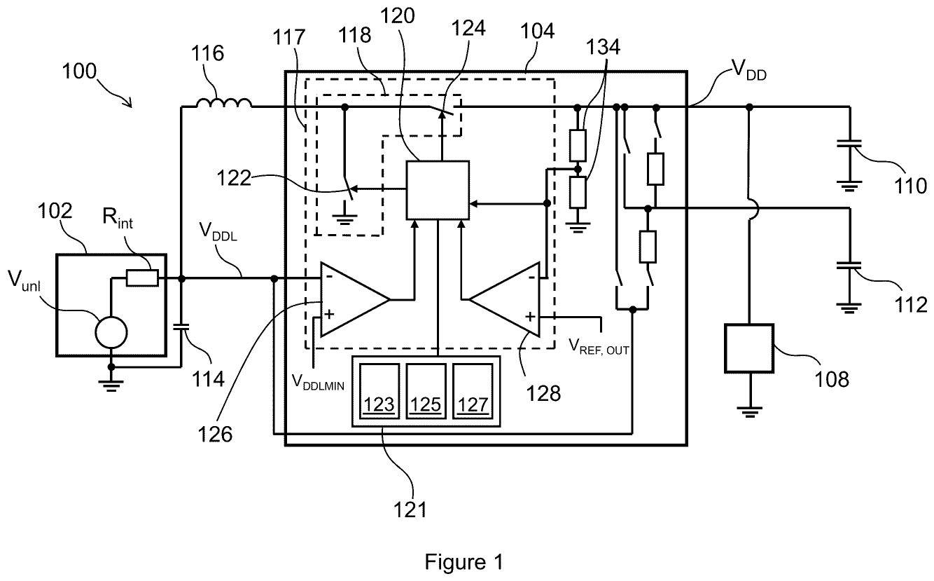

FIG. 1 shows a circuit system 100 comprising a battery 102, a boost converter circuit 104 and a System-on-Chip (SoC) 108. The battery 102 and the boost converter circuit 104 together power the SoC 108. As will be explained in more detail below, the boost converter circuit 104 receives an input voltage V_{DDL} from the battery 102 and provides a higher output voltage V_{DD} to the SoC 108. The SoC 108 requires a minimum operational voltage V_{DDRESET} of 1.7 V.

The normal operational voltage for the SoC 108 is between 1.8 and 3.6 V. Allowing for a small margin of error, the SoC 108 specifies a minimum voltage V_{DDMIN} of 2 V. The battery 102 has a non-zero internal resistance Rᵢₙₜ and an unloaded voltage Vᵤₙₗ. Rᵢₙₜ and Vᵤₙₗ vary depending on the state of charge of the battery 102 and the age of the battery 102. The unloaded voltage Vᵤₙₗ is typically between 1.1 V and 1.7 V. The internal resistance Rᵢₙₜ is typically around 20 Ω.

The SoC 108 is connected to the output voltage V_{DD} in parallel with a first decoupling capacitor 110 and a second decoupling capacitor 112. The second decoupling capacitor 112 has a larger capacitance than the first decoupling capacitor 110. During normal operation, the decoupling capacitors 110, 112 “decouple” the SoC 108 from any noise in the power supplied by the boost converter circuit 104, and also provide a charge reservoir for satisfying transient higher current demands from the SoC 108. Similarly, the boost converter circuit 104 itself is connected to the battery 102 in parallel with a battery decoupling capacitor 114. The battery decoupling capacitor 114 also acts to smooth noise and as a charge reservoir for the boost converter circuit 104.

The circuit system 100 comprises an inductor 116 with one terminal connected to the input voltage V_{DDL}, a boost circuit portion 117 and a discontinuous operation circuit portion 121. The boost circuit portion 117 comprises a switching arrangement 118, a boost control circuit portion 120, an input voltage comparator 126 and an output voltage comparator 128.

The boost control circuit portion 120 controls operation of the switching arrangement 118. The switching arrangement 118 comprises a first switch 122 operable to connect a second terminal of the inductor 116 to ground and a second switch 124 operable to connect the second terminal of the inductor 116 to the output of the boost converter 104. The boost control circuit portion 120 receives inputs from the input voltage comparator 126, the output voltage comparator 128 and the discontinuous operation circuit portion 121.

The discontinuous operation circuit portion 121 comprises a boost cycle counter 123, a boost cycle limiter 125 and a time-out timer 127.

The input voltage comparator 126 compares the input voltage V_{DDL} with a reference input voltage V_{DDLMIN}. The output voltage comparator 128 compares a divided version of the output voltage V_{DD}/α (with a determined by a pair of voltage divider resistors 134), with a reference output voltage V_{REF, OUT}. The reference output voltage V_{REF, OUT} is selected such that αV_{REF, OUT} equals a target output voltage. In this case, the target voltage is 3 V. The reference output voltage V_{REF, OUT} may be programmable, to correspond with different target voltages, e.g. for powering different SoCs.

When the boost converter circuit 104 is enabled, the boost circuit portion 117 operates to boost the first voltage V_{DDL} from the battery 102 to the output voltage V_{DD} by switching the first and second switches 122, 124 on and off repeatedly. Each cycle of boost converter operation involves the following steps:
1. The first switch 122 closes (with the second switch 124 open) and connects the right end of the inductor 116 to ground (0 V). The current through the inductor 116 ramps up with time, as does the magnetic field generated by the inductor 116. The length of time for which the first switch 122 is closed (and the resulting current set up in the inductor 116) is controlled by the boost control circuit portion 120 based on the output current requirement of the boost converter circuit 104.
2. The first switch 122 opens and the second switch 124 closes. Now, the right end of the inductor 116 is connected to the output of the boost converter circuit 104. The magnetic field in the inductor 116 will force the current to continue to flow in the same direction as before, to the output of the boost converter circuit 104. A voltage (e.m.f.) is set up over the inductor 116 in series with the input voltage V_{DDL}, to produce a higher output voltage V_{DD}.
3. When the current through the inductor 116 goes to zero, the second switch 124 opens. Both switches 122, 124 now remain open until the beginning of the next boost cycle. Alternatively, in a different mode of boost, the switches 122, 124 remain open until the output voltage V_{DD} falls below the reference output voltage V_{REF, OUT}.

In other words, the switches 122, 124 are controlled to repeatedly store energy in the magnetic field of the inductor 116 and then release this to produce the boosted output voltage V_{DD}. As long as sufficient current is supplied from the battery 102, this process maintains the output voltage V_{DD} at the predetermined target voltage at the output of the boost converter circuit 104.

The boost converter circuit 104 can operate in a continuous boost mode and a discontinuous boost mode. It is noted that these modes are not the same as continuous and discontinuous conduction modes which describe different current flow behaviours during a boost cycle. Instead, as will be explained in more detail below, the continuous and discontinuous boost modes refer to modes in which the boost cycles occur continuously or discontinuously.

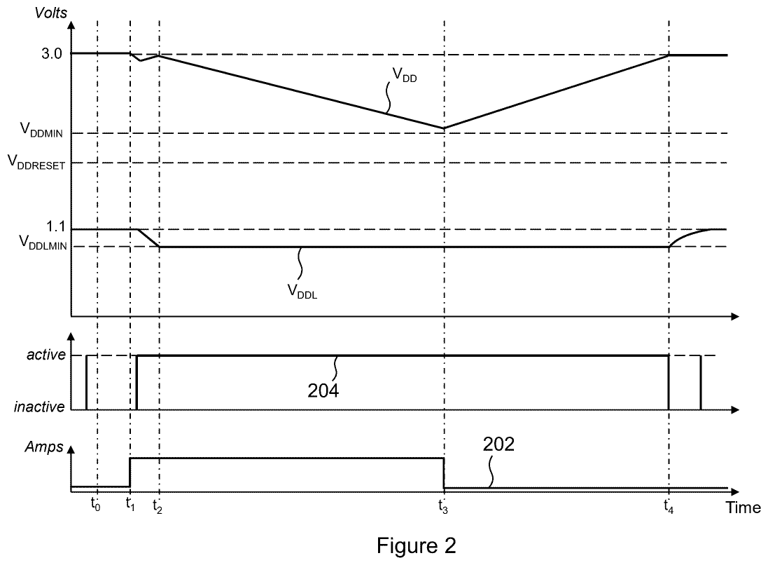

FIG. 2 is a timing diagram illustrating the operation of the boost converter circuit 104 using only the continuous boost mode, in which the boost converter circuit 104 remains in the active state whenever the output voltage V_{DD} is under the target voltage. FIG. 2 shows the input and output voltages V_{DD}, V_{DDL}, the load 202 drawn by the SoC 108, and the state 204 of the boost converter circuit 104.

At an initial time to, the SoC 108 is drawing no or very little load 202. The boost converter circuit 104 delivers a stable output voltage V_{DD} of 3.0 V, with the input voltage V_{DDL} at 1.1 V. Boost conversion cycles described above occur as needed to keep the output voltage at 3.0 V.

The current demanded by the SoC 108 varies. For instance, operations such as programming, transmitting and receiving may demand relatively large currents while other operations require very little current. At time t₁, the SoC 108 begins to draw an increased load 202 (e.g. because a transmission cycle begins) and the output voltage V_{DD} begins to drop. At first, the boost converter circuit 104 reacts by providing the necessary increased current, using charge supplied by the battery decoupling capacitor 114. However, as the charge on the battery decoupling capacitor 114 is used up, the increased current demand on the battery 102 causes V_{DDL} to drop (due to an increased voltage drop over the internal resistance Rᵢₙₜ).

At t₂, V_{DDL} drops to the reference input voltage V_{DDLMIN}. This causes the first comparator 126 to output a low signal to the control circuit portion 120. The control circuit portion 120 operates the boost circuit portion 117 to limit the input current drawn and prevent any further drop in the input voltage V_{DDL}.

Because the input current is limited, the boost circuit portion 117 can no longer provide sufficient current at the output to maintain the output voltage V_{DD}. The current demand at the output is met by the first and second decoupling capacitors 110, 112, and the output voltage V_{DD} slowly falls as the decoupling capacitors 110, 112 are discharged.

At t₃, the load 202 drops and the output current provided by the boost circuit portion 117 is now sufficient to recharge the output decoupling capacitors 110, 112. The output voltage V_{DD} starts to increase again. However, V_{DDL} remains at V_{DDLMIN} and so the input and output currents are still limited and it takes a relatively long time to recharge the output decoupling capacitors 110, 112. At t₄, the output voltage recovers to 3.0 V and the boost circuit portion 117 stops boost operation. The battery 102 can then recharge the battery decoupling capacitor 114 and the input voltage V_{DDL} recovers to 1.1 V.

Limiting the input current to prevent the input voltage V_{DDL} dropping too low can avoid excessive resistive losses over the internal resistance Rᵢₙₜ of the battery 102.

However, the boost converter 104 remains active throughout the load pulse whilst the input current to the boost converter circuit 104 is limited, and the quiescent current consumed by the boost converter circuitry (e.g. the comparators 126, 128 and the control circuit portion 120) can thus represent a significant fraction of the overall current drawn from the battery 102.

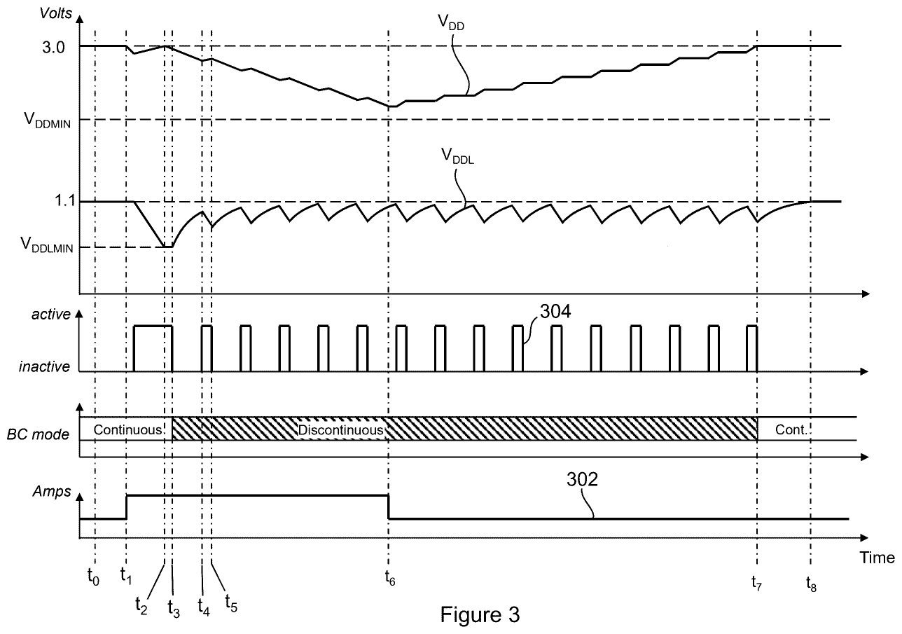

To address this, FIG. 3 illustrates an example of the present invention in which the boost converter circuit 104 can also be operated in a discontinuous boost mode. FIG. 3 shows the input and output voltages V_{DD}, V_{DDL}, the load 302 drawn by the SoC 108, the state 304 of the boost converter circuit 104 and the mode in which the boost converter circuit 104 is operating.

At an initial time t₀, the SoC 108 is drawing no or very little load 302. The boost converter circuit 104 delivers a stable output voltage V_{DD} of 3.0 V, with the input voltage V_{DDL} at 1.1 V. The boost converter operates with boost conversion cycles occurring as needed to keep the output voltage at 3.0 V.

At time t₁, the SoC 108 begins to draw an increased load 302 and the output voltage V_{DD} begins to drop. At first, the boost converter circuit 104 reacts by providing the necessary increased current with continuous boost conversion cycles, using charge supplied by the battery decoupling capacitor 114. As the charge on the battery decoupling capacitor 114 is used up, the increased current demand on the battery 102 causes V_{DDL} to drop. At t₂, V_{DDL} drops to V_{DDLMIN}.

The boost control circuit portion 120 monitors the output from the input and output voltage comparators 126, 128. When these signals indicate a drop in the input voltage V_{DDL} to V_{DDLMIN} and a 50 mV drop in the output voltage V_{DD} for 200 μs, the boost control circuit portion 120 enters into discontinuous boost mode operation.

At t₃ these conditions are met and the boost control circuit portion 120 enters into discontinuous boost mode operation. In other embodiments, discontinuous boost operation may be triggered by only a drop in the output voltage V_{DD}.

In this mode, instead of the boost converter circuit 104 operating continually whilst maintaining V_{DDL} at V_{DDLMIN}, the boost converter circuit 104 alternates between operating in an active state and an inactive state. In the active state, the boost circuit portion 117 operates to boost the first voltage V_{DL} from the battery 102 to the output voltage V_{DD} by switching the first and second switches 122, 124 on and off repeatedly as explained above. In the inactive state, boost conversion stops and most of the components of the boost converter circuit 104 are powered off to minimise quiescent current.

The first period of inactive state operation starts at t₃. The inactive state is governed by the time-out timer 127, which times a fixed inactive duration of 200 μs. During this period, the boost converter circuit 104 does not provide any current to the output, and the output voltage V_{DD} drops as charge is used from the decoupling capacitors 110, 112. However, the boost converter circuit 104 is also not drawing any current from the input, and so the input voltage V_{DDL} recovers as the battery decoupling capacitor 114 is recharged from the battery 102.

The inactive duration expires at t₄, and the time-out timer 127 triggers the boost converter circuit 104 to re-enter the active state. Boost conversion cycles resume. Because the input voltage V_{DDL} is not at V_{DDLMIN}, the input current is not limited and sufficient output current can be delivered to increase the output voltage V_{DD}. V_{DDL} drops back towards V_{DDLMIN}.

The active state operation is governed by the boost cycle counter 123 and the boost cycle limiter 125. The boost cycle counter 123 counts the number of boost cycles that have been performed by the boost circuit portion 117. The boost cycle limiter 125 compares this count to a predetermined limit of cycles, e.g. 19 cycles. When this number of cycles has been performed, the boost cycle limiter 125 triggers the boost converter circuit 104 to go back into the inactive state again at t₅.

The discontinuous boost process repeats whilst the output voltage V_{DD} remains below the target voltage. Whilst the load pulse is ongoing, the output voltage V_{DD} drops towards the minimum output voltage V_{DDMIN}. At t₆, the load pulse ends, and the discontinuous boost process slowly recharges the output capacitors 110, 112 back towards the 3.0 V.

At t₇, the output voltage V_{DD} recovers to 3.0 V and the boost circuit portion 117 stops boost operation, because the output voltage V_{DD} is no longer below the target voltage. This triggers the boost control circuit portion 120 to exit the discontinuous boost mode. The battery 102 can then recharge the input capacitor 114 and the input voltage VDDL recovers to 1.1 V at t₈.

Thus, the boost converter circuit 104 delivers sufficient energy to meet the load pulse whilst only being active in short periods. This reduces energy loss to quiescent currents and improves efficiency. The approach shown in FIG. 3 has been simulated to deliver overall efficiencies of 82-83%, compared to ˜65% for the approach illustrated in FIG. 2.

The predetermined cycle limit set in the boost cycle limiter 125, and the inactive duration set in the timer-out timer 127 are selected based on the expected performance of the circuit system 100, to ensure that V_{DDL} remains above V_{DDLMIN} and V_{DD} remains above V_{DDMIN} throughout an expected load pulse. The predetermined cycle limit and the inactive duration may be adjusted dynamically by the boost control circuit portion 120 as the circuit system 100 is used, e.g. to optimise the lengths of the active and inactive periods for different load pulses and/or as the battery 102 discharges and ages.

In some embodiments, the boost converter circuit 104 may only be operable in the discontinuous boost mode, e.g. with the boost conversion controlled by the boost cycle limiter 125 and the timer-out timer 127 whenever the output voltage V_{DD} drops below a target voltage. This may provide further efficiency benefits and/or simplify the circuitry.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A boost converter circuit comprising:
an input arranged to receive an input voltage from a power source;
an output arranged to generate a higher, output voltage for powering a further circuit portion; and
a boost circuit portion operable to transfer energy from the input to the output;
wherein the boost converter circuit is arranged to operate in a discontinuous boost mode in which, when the output voltage is below a target output voltage, the boost converter circuit alternates between an active state in which the boost circuit portion transfers energy from the input to the output and an inactive state in which the boost circuit portion is turned off and energy is not transferred from the input to the output.

2. The boost converter circuit of claim 1, comprising one or more oscillators, logic circuits, comparators, reference voltage supplies and/or bias current generators which are arranged to turn off in the inactive state.

3. The boost converter circuit of claim 1, arranged such that the input voltage does not drop below a minimum input voltage when in the active state.

4. The boost converter circuit of claim 1, arranged, when in the discontinuous boost mode, to operate in the active state for a predetermined active duration before transitioning to the inactive state.

5. The boost converter circuit of claim 1, arranged, when in the discontinuous boost mode, to operate in the active state for a predetermined number of boost cycles before transitioning to the inactive state.

6. The boost converter circuit of claim 5, wherein the number of boost cycles is selected by the boost converter circuit based on one or more present conditions of the boost converter circuit.

7. The boost converter circuit of claim 1, wherein the boost converter circuit is arranged, when in the discontinuous boost mode, to operate in the inactive state for a predetermined inactive duration before transitioning to the active state.

8. The boost converter circuit of claim 7, wherein the inactive duration is selected by the boost converter circuit based on one or more present conditions of the boost converter circuit.

9. The boost converter circuit of claim 8, comprising a discontinuous operation circuit portion arranged to control the boost circuit portion in the discontinuous boost mode, the discontinuous operation circuit portion comprising a time-out timer arranged to measure periods of inactive state operation and trigger a transition to the active state when the inactive duration expires.

10. The boost converter circuit of claim 9, wherein the time-out timer is the only component of the boost converter circuit that remains turned on in the inactive mode.

11. The boost converter circuit of claim 1, arranged to operate only in the discontinuous boost mode.

12. The boost converter circuit of claim 1, arranged to operate in a continuous boost mode in which, when the output voltage is below a target output voltage, the boost circuit portion continuously transfers energy from the input to the output.

13. The boost converter circuit of claim 12, arranged to operate in the continuous boost mode or the discontinuous boost mode in response to a level of or change in the input and/or output voltage.

14. The boost converter circuit of claim 12, arranged to operate in the discontinuous boost mode in response to a drop in the output voltage.

15. The boost converter circuit of claim 12, arranged to transition to the continuous boost mode from the discontinuous mode if the output voltage drops below a minimum allowable level.

16. The boost converter circuit of claim 1, arranged to transition from the active state to the inactive state whilst the output voltage is below the target output voltage.

17. The boost converter circuit of claim 1, arranged such that, when operating in the discontinuous boost mode, the output voltage drops towards a minimum output voltage across multiple alternations of the active and inactive states.

18. The boost converter circuit of claim 1, arranged such that, when operating in the discontinuous boost mode, the output voltage recharges towards the target voltage across multiple alternations of the active and inactive states.

19. A circuit system comprising:
a power source arranged to generate an input voltage; and
a boost converter circuit comprising:
an input arranged to receive the input voltage from the power source;
an output arranged to generate a higher, output voltage for powering a further circuit portion; and
a boost circuit portion operable to transfer energy from the input to the output;
wherein the boost converter circuit is arranged to operate in a discontinuous boost mode in which, when the output voltage is below a target output voltage, the boost converter circuit alternates between an active state in which the boost circuit portion transfers energy from the input to the output and an inactive state in which the boost circuit portion is turned off and energy is not transferred from the input to the output.

20. The circuit system of claim 19, wherein the power source comprises a battery.
